(19) United States
(12) Patent Application Publication
(10) Pub. No.: US 2010/0071723 A1
(43) Pub. Date: Mar. 25, 2010

(54) Reusable filter and regeneration station

(76) Inventors: Patrick Dugan, Lake Wylie, SC (US); Loy M. Clemmer, Gastonia, NC (US)

Correspondence Address: JOSEPH DELMASTER, 51056 ARRIETA COURT, FORT MILL, SC, 29707, US

(21) Appl. No.: 12/456,637

(22) Filed: Jun. 19, 2009

Related U.S. Application Data
(60) Provisional application No. 61/132,622, filed on Jun. 20, 2008.

(51) Int. Cl. B01D 35/16; B08B 9/00; B08B 3/08

(52) U.S. Cl. 134/22.18; 134/99.1

(57) ABSTRACT

A combination of a reusable fluid filter and a cleaning/regeneration apparatus that cleans a used filter and returns it to like-new condition for reuse. The filter comprises a container and a filter medium, the latter of which is a combination of coarse and fine wire mesh layers. The wire mesh may be cleaned and returned to usable condition using the regeneration station. The regeneration station comprises a reservoir having a cleaning medium, a filter mount, a compressed gas inlet, and a circulating pump supplying cleaning medium to the filter to be cleaned.

### PRIORITY CLAIM (US)

This application claims priority from a provisional patent application, Ser. No. 61/132,622, filed 20 Jun. 2008.

### FIELD OF THE INVENTION

The present invention pertains to the field of engine equipment service products, particularly a reusable fluid filter and a cleaning and regeneration station for returning a used filter to clean condition for further use.

### BACKGROUND OF THE INVENTION

Various types of motorized equipment operate with engines that require fluid filters. In this application, the most commonly referenced filter will be an engine oil filter though it should be understood that the invention is not limited to engine oil filters, but rather may apply to transmission oil filters and any other type of fluid filter constructed to be reusable.

The inefficiency, waste, environmental hazards and the like attributed to used fluid filters, especially oil, are well documented. These disposable units are designed for one use and are not designed nor intended to be cleaned. Prior systems only address the partial removal of oil from these disposable units. Most require special preparation of the filter and/or the use of water as a back flushing agent, as oil and water do not mix and thus can be separated.

Replacing disposable filters with filters that are capable of cleaning and reuse mitigates inefficiency, waste and environmental hazards. These benefits can be realized through the use of reusable filters combined with a cleaning and regeneration station in which the filters can be cleaned prior to reuse. The filters could be cleaned and used hundreds of cycles before replacement of a filter was necessary.

### SUMMARY OF THE INVENTION

A first aspect of the invention is a reusable fluid filter. The filter comprises a combination of coarse and fine wire mesh core that suspends contaminants within the mesh. Once used, the filter can be cleaned and returned to usable condition using the regeneration station described herein.

The second aspect of the invention is a regeneration station that relates generally to a cleaning apparatus and more specifically to a custom designed system tailored for the complete restoration of a fluid filter which is of a reusable design. Such fluid filters are generally comprised of a wire mesh cartridge which by its nature is well suited to multiple applications and can far outlast traditional cellulose fiber cartridges.

It is the object of the invention to provide a novel, functional system whereby said reusable fluid filters can be effectively restored to their original condition and be reentered into useful service over multiple cycles.

It is also an object of the invention to provide a novel system whereby reusable fluid filters will replace disposable units, thus reducing the inherent waste of materials which must be dedicated to every disposable unit and are subsequently of little or no use.

It is a further object of the invention to provide a unique system to significantly reduce the use of disposable filters which contaminate precious land and water sources by virtue of such used oil and other materials trapped in the fibrous paper cartridges leaching into their surroundings.

It is also a further object of the invention to provide a unique system to enable reusable fluid filters to be maintained on an ongoing basis for many cycles without having to disassemble and subsequently reassemble said fluid filter, thus greatly reducing time, related costs and eliminating potential human errors.

### BRIEF DESCRIPTION OF THE DRAWINGS

For the purpose of illustrating the invention, there is shown in the drawings a form of the invention that is presently preferred; it being understood, however, that this invention is not limited to the precise arrangements and instrumentalities shown.

FIG. 1 is a perspective view of the regeneration station.

FIG. 2A is a side partial section view of the regeneration station.

FIGS. 2B and 2C are plan views of one end (2B) and the top (2C) of the regeneration station.

FIG. 3 is a section view of a reusable filter.

### DESCRIPTION OF THE INVENTION

The regeneration station and reusable filter are described in detail herein. The regeneration station will be described first because it is critical to the reusability of the filter. In the following description, references to the “filter” are inclusive of any type of fluid filter designed for reuse after serving in its intended capacity (such as an engine oil filter or transmission fluid filter) for a period of time.

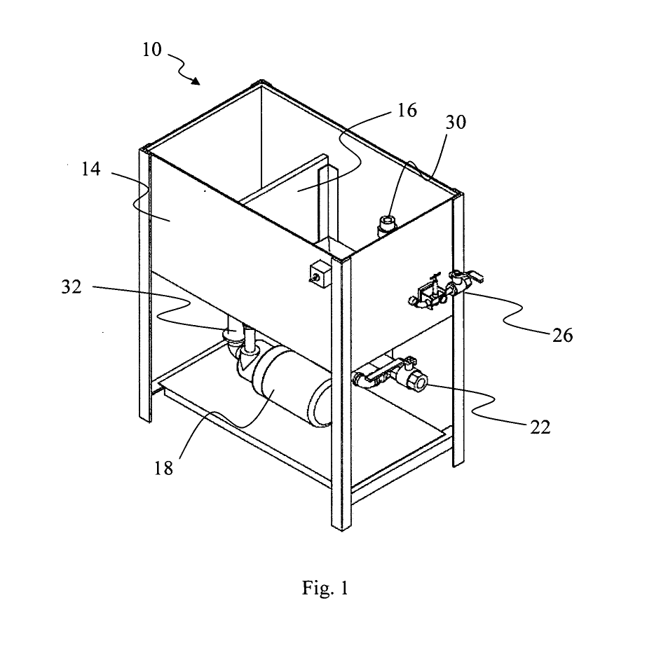

Referring now to FIG. 1, there is shown a reusable filter regeneration station 10. In the illustrated exemplary embodiment, the regeneration station comprises a fluid reservoir 14, which in operation contains the cleaning medium that flushes sludge and used oil (or other substance) out of the filter (not shown). The filter is mounted on the filter mount 30, which is a short standpipe topped by a threaded connector sized to fit the filter to be mounted upon it. The connector can be removed from the standpipe and a different sized connector mounted in its place to accommodate filters of various sizes.

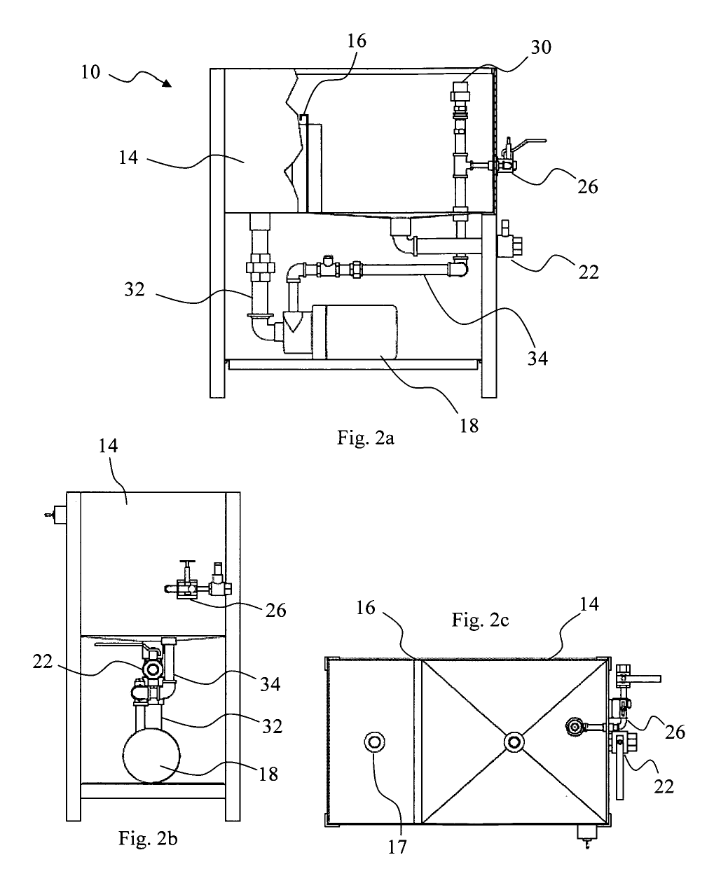

In the embodiment of the invention illustrated in FIGS. 1 and 2, the reservoir 14 is divided into two chambers by a weir 16 mounted within the reservoir. The weir separates two zones within the reservoir. The portion of the reservoir that contains the filter mount 30 is an area of significant fluid agitation as a cleaning medium is pumped into and through the filter, exiting the bottom of the filter at considerable velocity. In operation this chamber contains significantly contaminated cleaning medium. Preferably, during operation there can be particulate settling into the bottom of the first chamber via combination of gravity and special additive which promotes the coagulation of soot out of solution and into suspension.

The remaining portion of the reservoir, on the other side of the weir 16, is a zone where the cleaning medium is drained (or suctioned) from the reservoir to be recirculated through the filter. The weir 16 is intended to be a short intermediate divider within the reservoir over which the cleaning medium flows during the cleaning process, leaving a large amount of contaminants in the other chamber under the filter.

A pump 18 serves to supply cleaning medium to the filter under pressure. That pressure may be variable depending on the cleaning medium and the viscosity of the fluid that can pass through the filter internal mesh at the chosen pressure. The pump 18 pushes cleaning medium through a supply pipe 34 (FIG. 2A) into the filter mount 30 standpipe and the filter. The cleaning medium enters the filter, passes through it, then drains from the filter under pressure into the reservoir 14. While cleaning continues, the cleaning medium drains or is suctioned from the reservoir 14 through a filter cartridge 17 in the reservoir (FIG. 2C) on the other side of the weir 16 and is recirculated through the drain pipe 32, the pump 18 and the supply pipe 34.

The filter cartridge 17 in the reservoir traps residual particulate matter that is flushed from the filter attached to the filter mount 30. The cleaning medium is thus itself cleaned so that residual particulates are not recirculated through the filter undergoing the cleaning operation.

The initial supply of cleaning medium flows into the regeneration station reservoir 14 through a filler pipe and fitting 22. A sufficient quantity of cleaning medium should be introduced into the reservoir 14 to fill it to a level that exceeds the height of the weir 16 so that medium may flow from the filter cleaning chamber, over the weir, into the secondary filter chamber where the secondary filter cartridge 17 and drain pipe 32 are disposed.

Finally, a pressurized air supply fitting 26 is provided. The pressurized air supply fitting 26 is connected to the filter mount 30 standpipe. Pressurized air is introduced into the filter being cleaned for reuse after the cleaning medium begins to spill from the filter without significant discoloration, indicating that the filter is effectively cleaned. The pressurized air is blown through the cleaned filter to evacuate all cleaning medium from the filter housing and leave it essentially dry for reuse. The pressurized air may also be a gas, such as nitrogen, helium or other inert gas (not oxygen or hydrogen).

The pressurized gas may also be introduced into the filter mount standpipe along with cleaning medium during the cleaning operation. In some instances the addition of pressurized gas during cleaning results in a more effective cleaning, a faster cleaning cycle, or both.

The cleaning medium is chosen for effectiveness given the fluid residue that must be removed from the reusable filter during the cleaning operation. For simple engine oil of low viscosity (less viscous), simple soapy hot water may be sufficient to clean the filter for resuse. Higher viscosity fluids may require solvents as the cleaning medium. The selection of the proper medium is a choice made by the operator. The system is not dependent on any special cleaning agents.

A general description of the regeneration station and its operation follows. The regeneration station apparatus 10 comprises a fluid filter cleaning system having a segmented reservoir 14 with a tubular filter mount 30 standpipe to which the filter to be restored is secured at the top end via a threaded quick disconnect assembly. This standpipe serves as the conduit for the supply of cleaning medium held in the reservoir 14.

Said cleaning medium is then introduced into the filter being cleaned for reuse under high volume pressurized flow provided by an exteriorly mounted supply pump 18 under said reservoir. This high volume fluid flow may be augmented through the introduction of an external compressed air source which attaches to a quick disconnect and associated one way check valve 26 incorporated into the fluid supply line.

The cleaning medium is directed into the reusable filter (not shown) from the center bottom threaded connector on the filter. The cleaning medium is pumped into the filter chamber and in conjunction with compressed air and fills the filter cavity, effectively reversing the normal flow and enabling the particulate contamination held in the wire media to exit the filter and be discharged via the perimeter discharge openings of said renewable fluid filter.

The compressed air can thus be introduced simultaneously with the cleaning medium or independently into the reusable filter. This provides a dual function of both augmenting the high volume flow of cleaning medium and subsequently enabling the forced air evacuation of such fluids from the filter itself.

The segmented reservoir 14 is partitioned into two chambers via a removable weir 16 which serves to isolate the discharge fluid from the reusable filter and prevent particulate contamination from passing beyond it. As most of the particulate settles to the bottom of the segmented chamber underlying the filter being rejuvenated, the cleaning medium then traverses the weir and spills into the second segmented chamber. This chamber contains a submerged in line filter cartridge which is detachably secured to the pipe which directs filtered fluid flow back to the mechanical supply pump. This submerged cartridge filter thus serves to trap any residual particulate contamination which was not retained in the cleaning chamber. A bottom magnet (not shown) may be disposed in the reservoir serving to aid in trapping metallic particulate. This precludes the reintroduction of particulates into the core of the filter which is being restored.

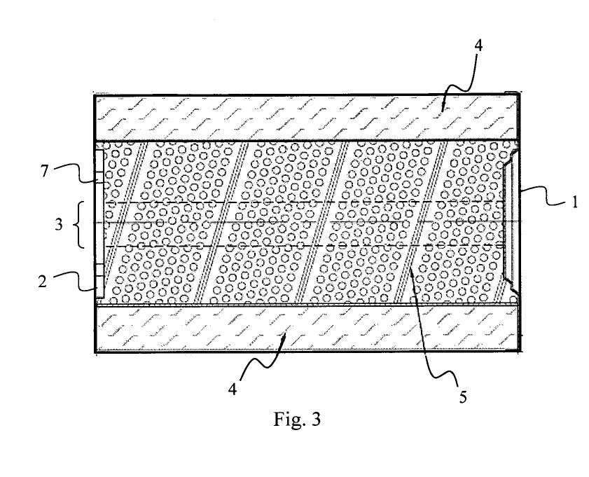

The reusable filter construction is illustrated in FIG. 3. The reusable filter is distinguished from a disposable filter by the interior substance that traps particulates suspended in engine oil for example. Referring to FIG. 3, the filter comprises a combination of coarse 4 and fine 5 wire mesh core that suspends contaminants within the mesh. Once used, the filter can be cleaned and returned to usable condition using the regeneration station described herein.

The reusable filter assembly comprises an enclosure 8 having a bottom cap 2 that is threaded for attachment to another structure, such as an engine. The filter may comprise a top cap 1 or the enclosure may be a one-piece structure open only at the bottom, where the bottom cap 2 is located. The bottom cap has a central opening 3 into a channel (shown in phantom lines) that extends through the center of the filter. The bottom cap also has openings 7 around the periphery of the bottom surface.

Inside the filter and surrounding the central channel are two grades of durable mesh material. A coarse grade 4 of mesh material forms the outer layer while a fine grade 5 fills the interior of the filter around the central channel. Because the interior of the filter comprises a durable mesh material, such as fine wire, it may be cleaned in the regeneration station and reused whereas paper core disposable filters may not.

In normal use, a fluid such as oil enters the filter under pressure through the central opening 3. The fluid is dispersed within the filter body 8 and passes through the mesh material, leaving particulate contaminants suspended in the mesh. The fluid exits the filter through the peripheral openings 7 in the bottom cap 2.

In the regeneration station, the cleaning medium is pumped into the filter under pressure through the central opening 3. The cleaning medium suffuses the inner mesh material 4, 5 and flows out through the peripheral openings 7 in the bottom cap. As it does, the cleaning medium carries away the contaminant particulates that were suspended in the mesh material. After a short time, the interior of the filter is cleaned of virtually all contaminants and is ready for reuse. The durable interior mesh 4, 5 of the filter can be cleaned many times.

The reusable filter and regeneration station system significantly reduce the use of disposable filters which contaminate precious land and water sources by virtue of such used oil and other materials trapped in the fibrous paper cartridges leaching into their surroundings. The system of the invention enables reusable fluid filters to be maintained on an ongoing basis for many cycles without having to disassemble and subsequently reassemble said fluid filter with a new core, as is sometimes done, thus greatly reducing time, related costs and eliminating potential human errors.

We claim:

1. A regeneration apparatus for cleaning one or more reusable filters comprising:
a fluid reservoir; a cleaning medium supply port; a pressurized gas inlet; a filter mount for the reusable filter; a circulating pump; and reservoir drain and supply pipes connected to the pump for circulating cleaning medium through the filter and reservoir.

2. The regeneration apparatus of claim 1, further comprising a removable weir separating the reservoir into at least two chambers.

3. The regeneration apparatus of claim 1, further comprising a quick disconnect assembly on said filter mount.

4. The regeneration apparatus of claim 1, further comprising a cleaning medium.

5. The regeneration apparatus of claim 1, further comprising a reusable filter disposed on the filter mount.

6. The regeneration apparatus of claim 1, further comprising a secondary filter disposed in the reservoir.

7. The regeneration apparatus of claim 1, further comprising a magnet disposed in the reservoir.

8. The regeneration apparatus of claim 5, wherein the reusable filter further comprises a cleanable wire mesh material.

9. An process for cleaning/restoring reusable fluid filters comprising supplying pressurized solvent from a segmented solvent supply tank to a bottom end of a fluid filter attachment pipe comprised of an exteriorly mounted high volume pump/motor assembly with a high pressure one way compressed air valve and associated fitting to augment the high flow of solvent being introduced into the fluid filter being restored.
